(19) United States
(12) Patent Application Publication
(10) Pub. No.: US 2021/0089981 A1
(43) Pub. Date: Mar. 25, 2021

(54) SYSTEM AND METHOD FOR ASSISTED PLACEMENT OF SALESPERSONS ON A SALES FLOOR

(71) Applicant: Toshiba TEC Kabushiki Kaisha, Shinagawa-ku (JP)

(72) Inventor: Christopher NGUYEN, Lake Forest, CA (US)

(21) Appl. No.: 16/578,656

(22) Filed: Sep. 23, 2019

(51) Int. Cl. G06Q 10/06; G06Q 10/08; G06Q 30/02; G06K 9/00

(52) U.S. Cl. CPC G06Q 10/0637; G06Q 10/087; G06K 9/00771; G06Q 30/0201; G06Q 10/063118

(57) ABSTRACT

A system and method for placing sales associates on a retail sales premises floor includes retrieving purchasing data including information on previous customer location patterns and associated sales information. This data is analyzed relative to current inventory data including information on currently displayed products, product locations and product promotions, along with current customer clustering as determined by heat signatures received from overhead digital cameras. A processor determines, from the purchasing data, the current inventory data and customer locations, a recommended placement of sales associates on the retail floor.

### TECHNICAL FIELD

This application relates generally to selling inventory from a retail sales establishment. The application relates more particularly to optimized, dynamic placement of sales personnel on a sales floor to improve customer satisfaction.

### BACKGROUND

A traditional retail sales environment includes a sales floor wherein inventory is displayed for selection and purchase by visiting customers. Current retail stores include layouts wherein inventory is displayed throughout the premises. Selected purchases are paid for at checkout stations, typically positioned near exits. In department stores, checkout stations may be placed in or near areas where like goods are displayed, such as in a shoe section or appliance section. Department stores have advantages over stores where all checkout stations are near exits insofar as a sales clerk is available near the merchandise to assist in product placement or to answer customer questions. However, it can be expensive to build, maintain and staff checkout stations throughout a department store.

### BRIEF DESCRIPTION OF THE DRAWINGS

Various embodiments will become better understood with regard to the following description, appended claims and accompanying drawings wherein:

FIG. 1 is an example embodiment of a system 100 for assisted placement of salespersons on a sales floor;

FIG. 2 is an example embodiment of a point-of-sale device;

FIG. 3 is an example embodiment of a point-of-sale device;

FIG. 4 is an example embodiment of a system for assisted placement of salespersons on a sales floor;

FIG. 5 is an example embodiment of a user workflow for assisted placement of salespersons on a sales floor; and

FIG. 6 is a flowchart of operations of an example embodiment of a system for assisted placement of salespersons on a sales floor.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In a store environment, a retailer may use various sales strategies to increase sales or foot traffic such as shelf placements, promotions, discounts, etc. However, a retailer may not properly anticipate the long lines for check outs due to the sales strategies. A retailer may incur opportunity loss when customers are waiting in long lines for check outs at the store. Customers may elect to not wait and go elsewhere, they may not return to shop as frequently due to the experience of waiting in the long lines, or in extreme cases they may never return.

Long lines can be alleviated by deploying salespersons on the retail floor space. Dispersed employees are available to answer customer's questions or otherwise assist them with their purchases. A mobile salesperson may be equipped with a portable device to allow them to immediately checkout customer purchases without waiting in lines. But how and when to deploy the salespersons can be problematic. For example, placing salespersons throughout a store can be expensive in human resource cost.

Example embodiments herein provide a real time dynamic heat map of a retailer's store floor plan. The heat map illustrates a recommendation of where the salespersons presence should be to assist the customers using analytical data from the retailer's store sales transactions, promotional data, product pricing and shelf product placements. By using historical and predictive patterns of customer purchasing behaviors, the retailer can quickly and effectively deploy salespersons to anticipated key areas of the floor space to support check outs. Thus, reducing the opportunity loss and retaining customer loyalty for future opportunity gains.

A recommendation engine system regularly receives a store sales transaction information, such as every 5 minutes, and also can distribute promotional methods to the store. Combined with other type of store data such as the daily product inventory, product price, shelf placements, and the store floor plan, the system can quickly predict which products customers may be drawn to and when there would be the most foot traffic for each hour of the business day. The system provides feedback to the retailer of when and where there is a need for an employee or mobile point-of-sale presence within a floor space and how many salespersons are desirable. With optimized deployment of salespersons in particular floor spaces of the store environment, the retailer can greatly minimize the opportunity loss by allowing customers to quickly check out through the salesperson with mobile point-of-sale device. Additionally, the retailer may utilize the salespersons for other activities at non-peak hours thus preventing underutilization of human resources.

Example embodiments herein provides recommendation on when, where, and how many salespersons should be present on the floor space. Utilizing a dynamic heat map on the store floor plan, the salespersons can quickly target specific areas of the store throughout the day and not be locked into one area.

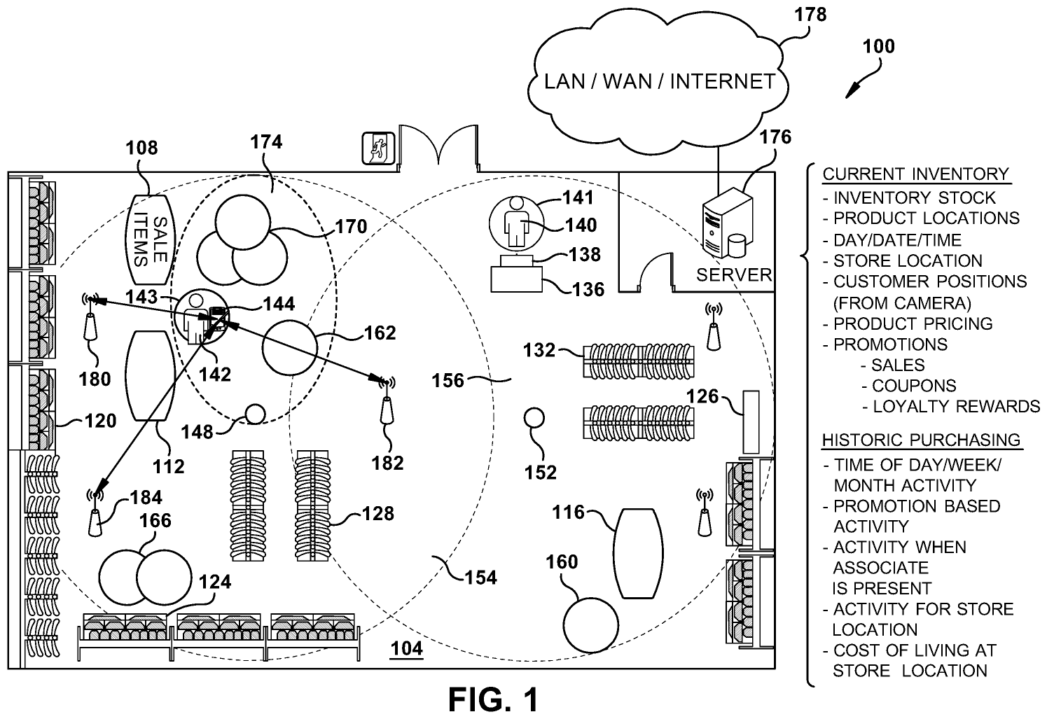

In accordance with the subject application, FIG. 1 illustrates an example embodiment of a system 100 for assisted placement of salespersons on a sales floor 104. Inventory is dispersed across the sales floor, such as with one or more display tables, such as display tables 108, 112 and 116, one or more display cases, such as display cases 120 and 124, one or more display shelves, such as shelf 126, or one or more display racks, such as clothing racks 128 and 132. Also illustrated is a checkout station 136, suitably staffed by sales clerk 140, which station includes a point-of-sales terminal 138. There are also one or more roving sales clerks, such as sales clerk 142 that can be deployed in various locations on the sales floor 104. In the illustrated embodiment, sales clerk 142 is provided with a mobile point-of-sale (POS) device 144, an example of which will be detailed below.

In the illustrated example, one or more cameras, such as cameras 148 and 152 are directed to sales floor 104 to capture one or more images thereof. Camera 148 is positioned to view area 154 while camera 152 is positioned to view area 156. It will be appreciated that suitable camera positioning facilitates image capture from most, if not all, of a retail floor. Cameras 148 and 152 are configured for digital image capture. Captured digital images can be used to determine locations of people on sales floor 104. In a particular example, heat sensitive imaging cameras, such as infrared cameras, are implemented. Humans exert a heat signature from their body heat relative to ambient temperature. When two or more humans are next to one another, a larger heat signature is formed from their combined body heat. A larger heat signature therefore provides a good depiction of an image where customers are clustered, which cluster detection can be simplified relative to recognition and placement of humans from digital photographs. Heat signatures 160 and 162 are sized so as to be each likely to be associated with a single human. Heat signature 166 is sized so as to be likely to be associated with two humans, and heat signature 170 is sized so as to be associated with three or more humans. It will be noted that sales clerks 140 and 142 are each associated with a heat signature, 141 and 143, respectively. A clustering area 174 is suitably isolated from heat signatures 162 and 170, which clustering area 174 is indicative of location of particular customer interest. In the illustrated example, clustering area 174 is associated with display table 108 which bears items for which prices have been marked down.

As will be detailed further below, sales associated 142 is suitably positioned to clustering area 174 in accordance with analysis of a current customer heat signature map, along with data indicative of both current store inventory as well as data corresponding to historic purchasing activity. Current inventory data, suitably housed on server 176, may include inventory stock, product locations, temporal information such as current time, day or date, store location, customer positions along the sales floor, promotions, such as sales, coupons or loyalty awards. Historic purchasing activity data may include activity associated with time, days, weeks or months, activity during earlier promotions, which may include identification of promotion types, activity when a sales clerk is present relative to activity when none is available, activity for a particular store location or activity relative to pricing levels and a cost of living at the store location.

Server 176 is suitably in data communication with network cloud 178, comprised of a local area network (LAN), wide area network (WAN), which may comprised the Internet, or any suitable combination thereof. With such connectivity, current and historic information is suitably shared with a home office or one or more additional retail sales establishments.

A location of a roving sales clerk, such as sales clerk 142, is suitably determined via a positioning system. By way of example, sales clerk 142 may be positioned relative to triangulation between their point-of-sale device 144 and one or more wireless access points, such as access points 180, 182 and 184. A position check is suitably made to determine when an associate is present in a recommended position.

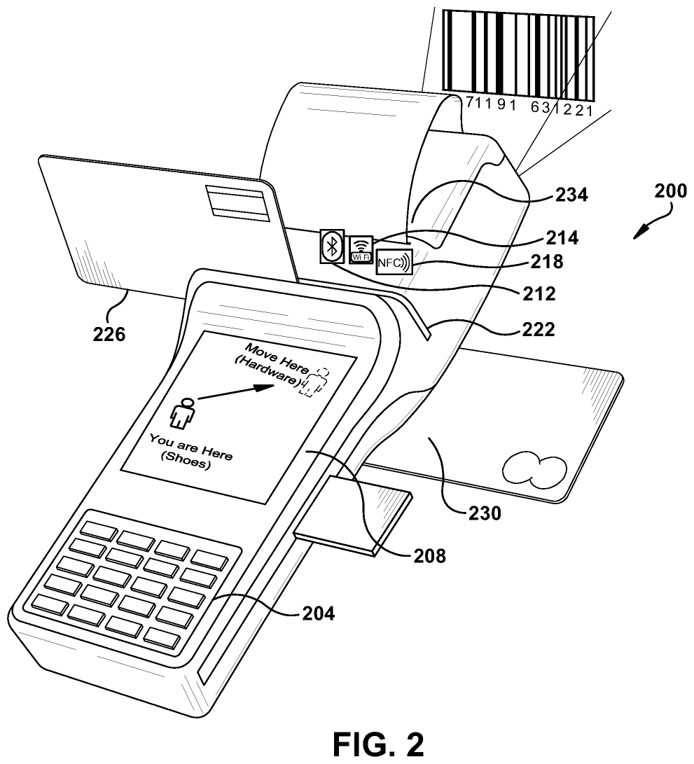

FIG. 2 illustrates an example embodiment of a POS device 200 comprised of a handheld unit. The unit includes a user interface comprised of integrated keyboard 204 and display 208. A wireless data interface is comprised of one or more of Bluetooth interface 212, Wi-Fi interface 214 and near field communication (NFC) interface 218. POS device 200 further includes a magnetic card reader 226, chip reader 230 and printer 234. It will be appreciated that a sales associate, armed with POS device 200, can complete product purchase transactions at any point in a retail premises, securing payment and printing a receipt. Inventory changes associated with such sale are suitably communicated wirelessly, such as to server 176 of FIG. 1. In the illustrated example, display 208 includes a graphic rendering for repositioning the sales associate to a different location on the retail premises as described above.

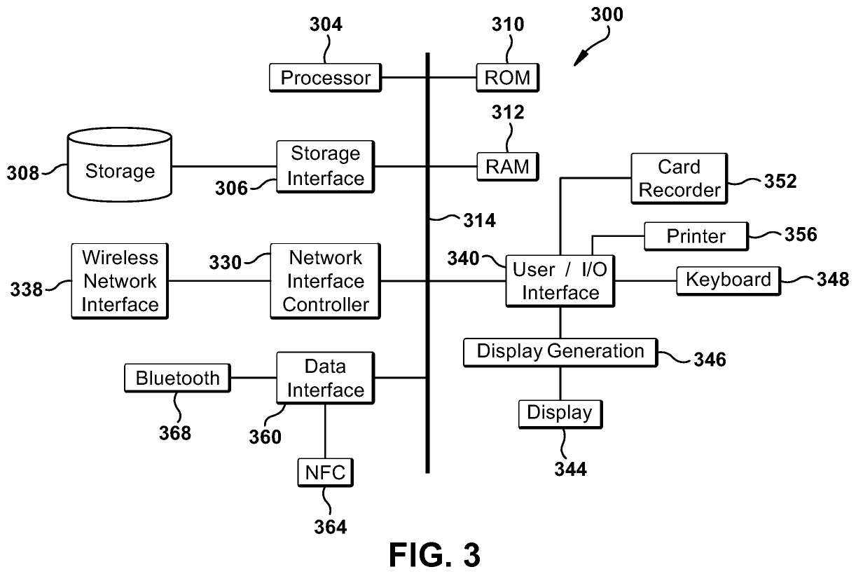

FIG. 3, illustrated is an example of a digital device system 300 suitably comprising POS device 234 of FIG. 2. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wireless data connection via wireless network interface 338. A suitable data connection to an MFP or server is via a data network, such as a local area network (LAN), a wide arear network (WAN), which may comprise the Internet, or any suitable combination thereof. A digital data connection is also suitably directly with an MFP or server, such as via BLUETOOTH, optical data transfer, Wi-Fi direct, or the like.

Processor 304 is also in data communication with a user input/output (I/O) interface 340 which provides data communication with user peripherals, such as display 344 via display generator 346, keyboard 348, as well as mice, track balls, touch screens, or the like. Also included is card reader 352 and printer 356. Data interface 360 provides for Bluetooth connection 368 and NFC connection 364. It will be understood that functional units are suitably comprised of intelligent units, including any suitable hardware or software platform.

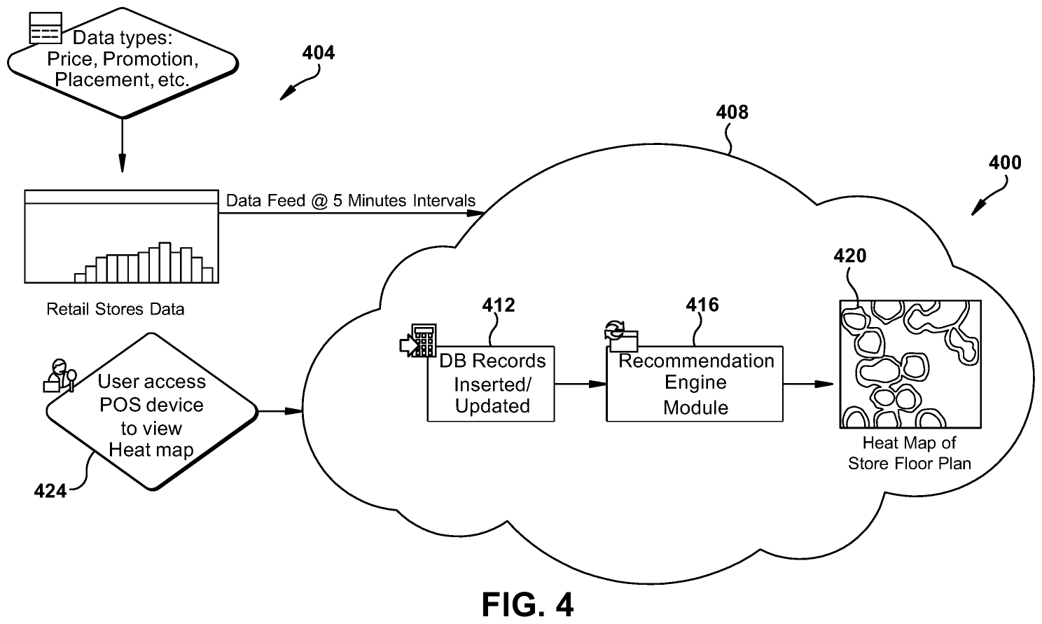

FIG. 4 is a hardware block diagram of an example embodiment of a system 400 for assisted placement of salespersons on a sales floor. In the illustration, data feed 404 comprised of current inventory data and historical purchasing data is provided at set intervals, such as at five minute intervals, at least during store hours, to network cloud 408. Network cloud 408 communicates feeds to an associated server wherein database records are updated at block 412, a sales associate position recommendation displayed at block 416 and a heat map of the store premises displayed at block 420. Such information is relayed for display on a sales associate's POS device at block 424.

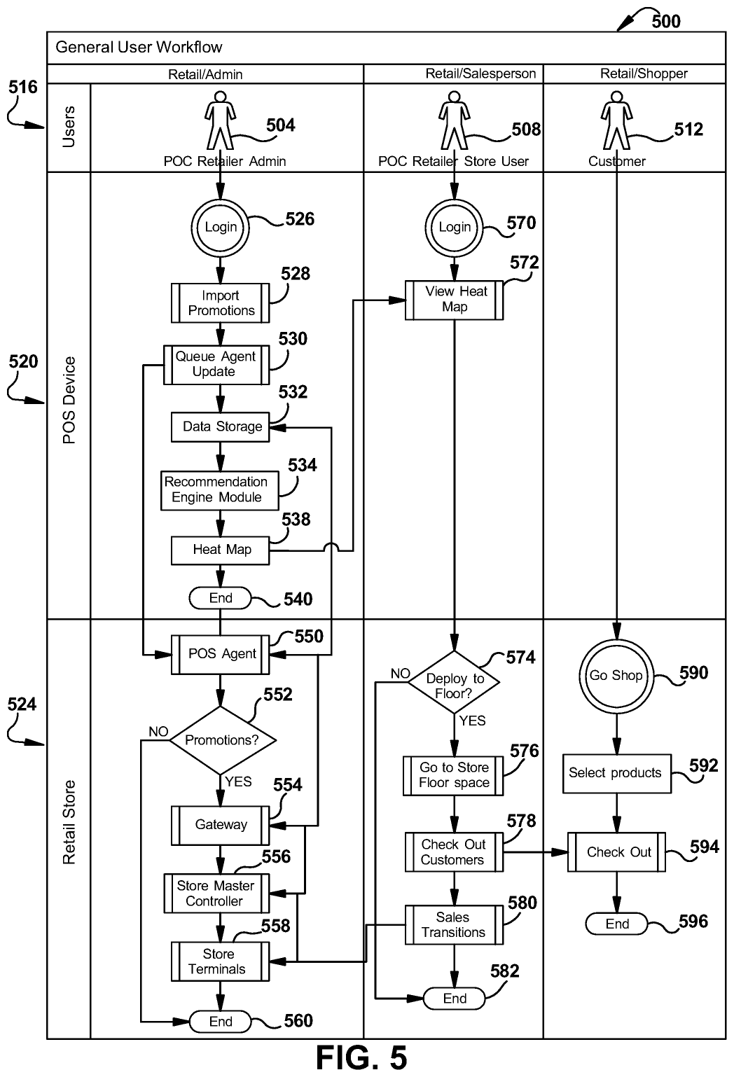

FIG. 5 is an example embodiment of a user workflow 500 for assisted placement of salespersons on a sales floor. The illustrated workflow 500 is between a retail administrator 504, retail salesperson 508 and retail shopper 512. Workflow environments include users 516, POS device(s) 520 and retail store 524. Retail administrator 504 commences with a POS device login at block 526. Next, promotions are imported at block 528, and a queue agent updated at block 530. The updated queue is stored at block 532 and a positioning recommendation is made at block 534. A heat map is generated at block 538, and the sub-process ends at block 540.

At retail store level 524, a POS agent is engaged at block 550 using queue information from block 530 and 532 as noted above. A check for promotions is made at block 552. If they exist, they are provided via a gateway at block 554, stored in a master controller at block 556 and propagated to store terminals at block 558, after which the sub-process ends at block 560. If no promotions are present at block 552, the process proceeds to end at block 560.

As to retail salesperson 508 on POS device 520, they commence with a device login at block 570 and view the heat map at block 572. At retail store level 524, if the salesperson is deployed to the floor at block 574, then they proceed as directed at block 576 to check out customers at block 578. Sales transactions are completed at block 580 and the sub-process ends at block 582. If the salesperson is not deployed at block 574, progress is made directly to termination at block 582.

As to retail shopper 512, activity is limited to retail store 524 where shopping is commenced at block 590. Products are then selected at block 592, and a checkout of merchandise is completed at block 594 in concert with salesperson 508 with block 578. After checkout at block 594, the shopper sub-process ends at block 596.

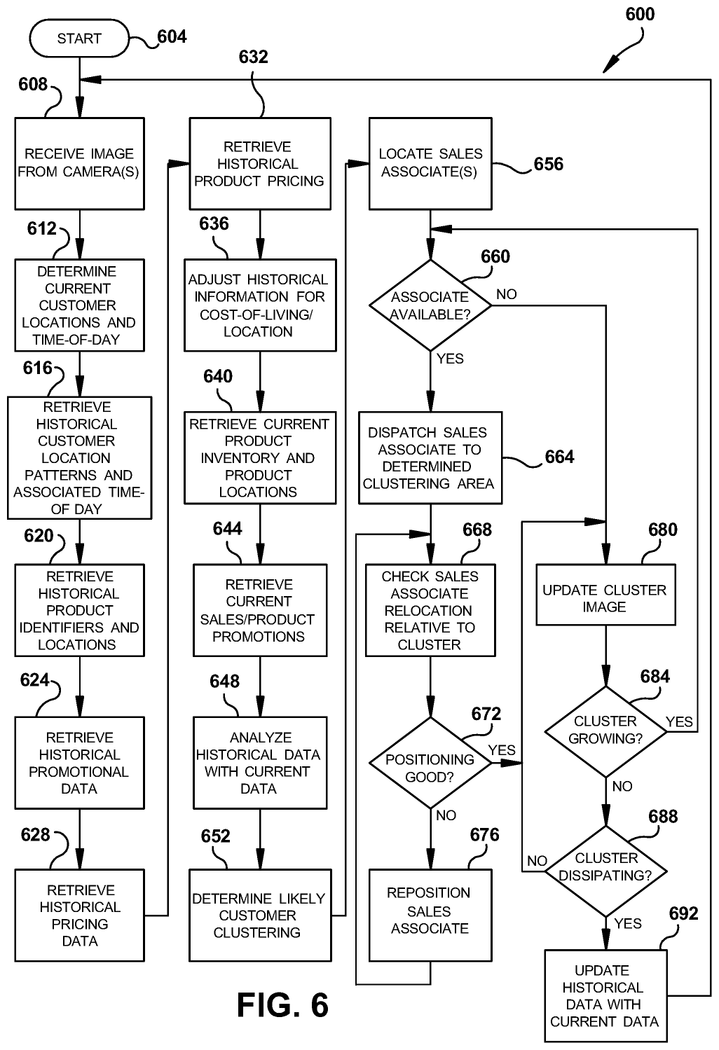

FIG. 6 is flowchart 600 of an example embodiment for assisted placement of salespersons on a sales floor. The process commences at block 604 and proceeds to block 608 wherein one or more images, such as a digital thermal image, is received from one or more cameras at block 608. A determination of customer locations and time of day is made at block 612, and historical customer location patterns and their associated time of day is retrieved at block 616. Historical product identifiers, such as product name, manufacturer name, product type or product SKU, along with corresponding product placement or locations is received at block 620. Historical promotional information is retrieved at block 624, historical pricing information obtained at block 628 and historical product pricing information retrieved at block 632. Adjustment is suitably made at block 636 to account for factors such as current cost of living or inflation rates. Current inventory product information and locations is retrieved at block 640. Historical data is analyzed relative to current data at block 648, and a determination as to likely customer clustering is made at block 652. A sales associate is identified or located at block 656. A check is made at block 660 as to whether the associated is available for deployment. If so, they are dispatched to the determined or recommended clustering area at block 664. A determination is made at block 668 of the associate's location relative to the cluster. If it is determined to be suboptimal at block 672, they are repositioned at block 676 and another check is made at block 668.

Once positioning of the sales associated is determined to be acceptable at block 672, an updated camera image is obtained at block 680. If the cluster is determined to be growing at block 684, the process returns to block 660 to determine if another associated is available. When no associate is available as determined by block 660, progress returns to block 680 for image updating. If a monitored cluster is not growing, a check is made at block 688 to see if it is dissipating. If not, progress returns to block 680. If so, historical data is updated with newly acquired data at block 692 and progress returns to block 608.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a processor;
a memory configured to store current inventory data corresponding current sales floor product inventory and associated product location for a retail sales premises;
a data interface; and
a camera configured to acquire digital image data of the retail sales premises,
wherein the memory is further configured to store historical purchasing data including historical customer location data corresponding to previously determined customer locations on the retail premises and corresponding historical sales data for product sales,
wherein the processor is configured to determine a recommended placement location of one or more sales associates on the retail sales premises in accordance with acquired digital image data, the historical purchasing data and the current inventory data, and
wherein the data interface is configured to output placement data to generate an image indicative of a determined recommended sales associate placement.

2. The system of claim 1 wherein processor is further configured to determine a customer cluster from acquired image data and determine the recommended placement location in accordance with a position of a cluster within the retail sales premises.

3. The system of claim 2 wherein the processor is further configure to determine a location of a sales associate relative to the cluster.

4. The system of claim 1 wherein the digital image data comprises a heat signature of the retail sales premises.

5. The system of claim 4 further comprising the camera configured to capture a series of digital images and wherein the processor is further configured to update the recommended placement location for each captured digital image.

6. The system of claim 1 wherein the historical purchasing data includes temporal data corresponding to one or more of a time or date associated with the historical location data and wherein the processor is further configured to determine the recommended placement location in accordance with one or more of a current time or date.

7. The system of claim 1 wherein the current inventory data includes data corresponding to sales or promotions associated with the current sales floor product inventory.

8. A method comprising:
retrieving, from a memory, current inventory data corresponding current sales floor product inventory and associated product location for a retail sales premises;
acquiring digital image data of the retail sales premises from a camera;
retrieving, from the memory, historical purchasing data including historical customer location data corresponding to previously determined customer locations on the retail premises and corresponding historical sales data for product sales;
determining, via a processor, a recommended placement location of one or more sales associates on the retail sales premises in accordance with acquired digital image data, the historical purchasing data and the current inventory data; and
outputting, via an associated data interface, placement data to generate an image indicative of a determined recommended sales associate placement.

9. The method of claim 8 further comprising determining a customer cluster from acquired image data; and
determining the recommended placement location in accordance with a position of a cluster within the retail sales premises.

10. The method of claim 9 further comprising determining a location of a sales associate relative to the cluster.

11. The method of claim 8 further comprising acquiring the digital image data comprised of a heat signature of the retail sales premises.

12. The method of claim 11 further comprising capturing a series of digital images and updating the recommended placement location for each captured digital image.

13. The method of claim 8 wherein the historical purchasing data includes temporal data corresponding to a time or date associated with the historical location data and further comprising determining the recommended placement location in accordance with a current time or date.

14. The method of claim 8 wherein the current inventory data includes data corresponding to sales or promotions associated with the current sales floor product inventory.

15. A system comprising:
a processor;
a memory;
a data interface; and
one or more digital cameras directed to a floor area of a retail sales premises configured to periodically capture images of the floor area,
wherein the memory storing inventory data corresponding to identified products and their associated position within the retail sales premises,
wherein the memory further stores historical sales data corresponding to sales of previous product inventory,
wherein the processor is configured to determine a desired position of a sales associate on the floor area in accordance with the inventory data and the historical sales data, and
wherein the processor is further configured to generate an image on an associated display corresponding to a determined desired position.

16. The system of claim 15 wherein the inventory data further comprises pricing data corresponding to a pricing of inventory items.

17. The system of claim 16 wherein the inventory data further comprises promotional data corresponding to current inventory promotions.

18. The system of claim 15 wherein the digital camera is comprised of an infrared camera and wherein the captured images include a heat signature of the floor area.

19. The system of claim 18 wherein the processor is further configured to update the desired position in accordance with each captured image.

20. The system of claim 19 wherein the data interface is configured to receive data corresponding to one or more sales transactions and update the inventory data in accordance therewith.
